(19) United States
(12) Patent Application Publication
(10) Pub. No.: US 2004/0255623 A1
(43) Pub. Date: Dec. 23, 2004

(54) Biometric padlock

(76) Inventors: Conrad Sun, Encinitas, CA (US); John Schwartz, Solana Beach, CA (US)

Correspondence Address: LEONARD TACHNER, A PROFESSIONAL LAW, CORPORATION, 17961 SKY PARK CIRCLE, SUITE 38-E, IRVINE, CA, 92614

(21) Appl. No.: 10/601,919

(22) Filed: Jun. 19, 2003

(51) Int. Cl. E05B 67/22

(52) U.S. Cl. 70/38 A

(57) ABSTRACT

A padlock having a body and a shoekle comprises a fingerprint sensor, a fingerprint data memory device and an electromagnetic device activated by a sensed and matched fingerprint to unlock the shackle from the body. Unlock and programming buttons respectively activate the sensor and configure the data memory device to receive new fingerprint data of those authorized to unlock the padlock.

### BACKGROUND OF THE INVENTION

1. Field of the Invention

The present invention relates generally to padlocks and more specifically to a biometric padlock which, in a preferred embodiment, functions as an electro-mechanical device utilizing fingerprint recognition to open the lock.

2. Background Art

Advances in the technology of fingerprint recognition have made it feasible to employ such technology to limit access to certain equipment to selected individuals. By way of example, U.S. Pat. Nos. 4,467,545 and 5,812,252 relate to the use of fingerprint recognition to activate a fire arm only for individuals who's fingerprint patterns have been previously stored. Similarly, U.S. Pat. Nos. 6,078,265 and 6,100,811 relate to fingerprint recognition for use in vehicles to limit access to vehicle operation to individuals who's fingerprint patterns have been previously stored. However, in the past the cost of fingerprint readers has limited fingerprint recognition to use with or in applications involving relatively expensive devices; i.e., guns, vehicles, etc. costing thousands of dollars. Unfortunately, not all applications that would benefit from fingerprint recognition involve such costly equipment. Nevertheless, it remains difficult to justify use of a fingerprint recognition system that is more costly by an order of magnitude than the rest of the equipment with which the reader is used.

On the other hand, if one considers the total savings produced by biometric security over many years in the form of heightened safety, increased convenience and saved time, applications that may at first appear uneconomical, can become more reasonable and justified, particularly when the costs are amortized over many years of use. Aside from cost considerations, one must of course also consider size constraints. Only recently has it become feasible to install fingerprint recognition devices and their attendant electronics into relatively limited volumes that would be required for some applications. By way of example, recently, fingerprint reader-based door locks for use with deadbolt systems, have begun to appear and are now available commercially. See for example: SOS DEPOT, an online security products company, offers a BIOTREE 3000 Fingerprint access panel which can be employed to permit access to selected areas only by individuals who's fingerprints have been previously stored.

There are still however, some applications that have not yet been implemented because at first blush they do not appear to be justified economically and they do not appear to be feasible in terms of size constraints. In other words, they are applications that are not obvious uses for fingerprint recognition. One such application is a biometric padlock. A biometric padlock would be ordinary or conventional in shape and size, but would not have a key hole or a combination dial. Instead it would have a fingerprint recognition sensor over which an authorized user wipes his or her finger to open the lock, which, of course, only occurs if that person's fingerprint data has been previously stored. Such a padlock would obviate holding a key or memorizing a combination code and would make it possible for one or more preselected individuals to open the lock in a simple and convenient manner which is nevertheless extremely secure.

### SUMMARY OF THE INVENTION

The biometric padlock is an electromechanical device that functions as a padlock, but utilizes fingerprint recognition for unlocking instead of requiring a key or combination lock.

To open the lock an authorized user wipes his or her finger across a built in line sensor on the face of the lock. If the fingerprint is recognized the lock unlocks.

The lock has several modes of operation:

1. Unlock—to open the device one pushes the U Button momentarily which wakes up the lock (applies power) and activates the sensor and electronics. The U button is positioned near the sensor to be automatically depressed prior to passing the finger over the sensor. The finger is passed over the sensor and within 1-2 seconds a solenoid in the lock releases the spring-loaded shackle, which then pops up.

2. Program—The lock first needs to be programmed to be able to recognize the users' fingerprints. Up to 8 fingerprints may be stored. To program the lock one opens the shackle, rotates it 180°, and pushes the shackle down until it detents in place. One then pushes the P (program) button on the back and wipes a finger across the sensor. If the print is received, an LED will light up green. If the print is not recorded it will flash red. There may be a requirement to repeat the programming step twice for security and accuracy purposes. The lock is returned to this position only for programming additional prints. When the capacity for the number of prints is reached, the red light will go on and the green light will not flash.

3. Lock—Simply pull up on the shackle, rotate it 180° (from the programming mode) and push down on the shackle to lock.

4. Remove programmed prints—To remove previously stored prints one is required to open the lock and hit the reset button (recessed below the casing using a paperclip.) The reset button will not work with the lock closed. There is no way to remove a subset of the fingerprints stored with the lock closed.

Battery—The lock is powered using a coin cell accessible via a screw cover on the back of the lock. This permits one to replace the battery if it expires while the lock is locked. However, even if the battery fails the lock will not open; its default position is in the closed locked condition.

### BRIEF DESCRIPTION OF THE DRAWINGS

The various embodiments, features and advantages of the present invention will be understood more completely hereinafter as a result of a detailed description thereof in which reference will be made to the following drawings:

FIG. 1 is a front view of an open biometric padlock in accordance with a preferred embodiment of the invention;

FIG. 1a is a side view of the padlock during fingerprint reading;

FIG. 2 is a rear view of the biometric padlock of FIG. 1;

FIG. 2a is a side view of the padlock during a “reset” operation;

FIG. 3 is a front view of the padlock of FIG. 1, but shown in its locked configuration;

FIG. 4 is a cross-sectional view of the padlock of FIG. 1; and

FIG. 5 is a block diagram of the fingerprint reader/padlock combination of the invention.

### DETAILED DESCRIPTION OF A PREFERRED EMBODIMENT

Referring to the accompanying drawings, it will be seen that a padlock 10 comprises a body 12, a locking arm or shackle 15, a biometric member 14, the latter comprising a “U” button 18, a line sensor or reader 16, a “P” button 20, a reset button 22, a battery access 24, a printed circuit board (PCB) 26, a sensor board 28, a solenoid 30, a magnetic pole 32, a locking pin 34, a spring 35 and a shackle recess 36.

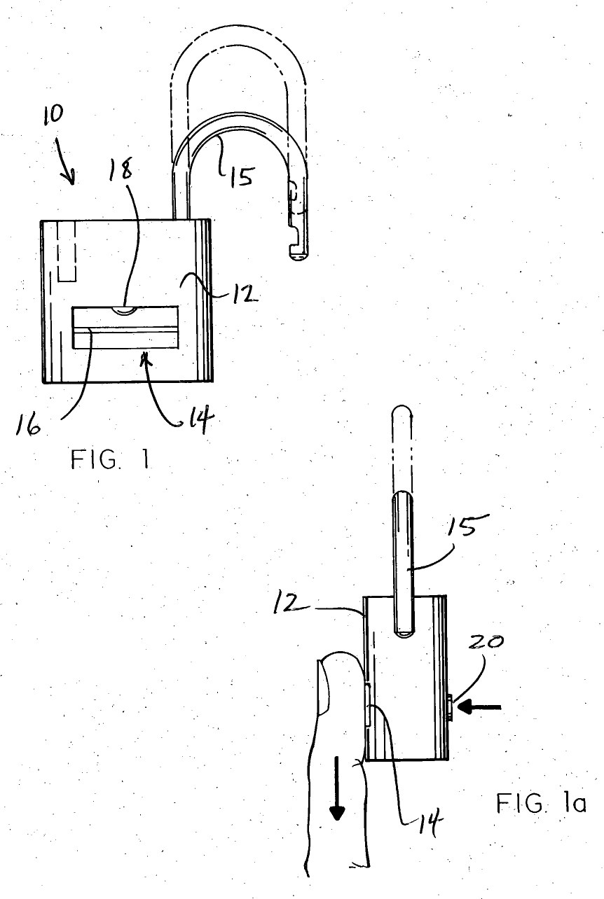

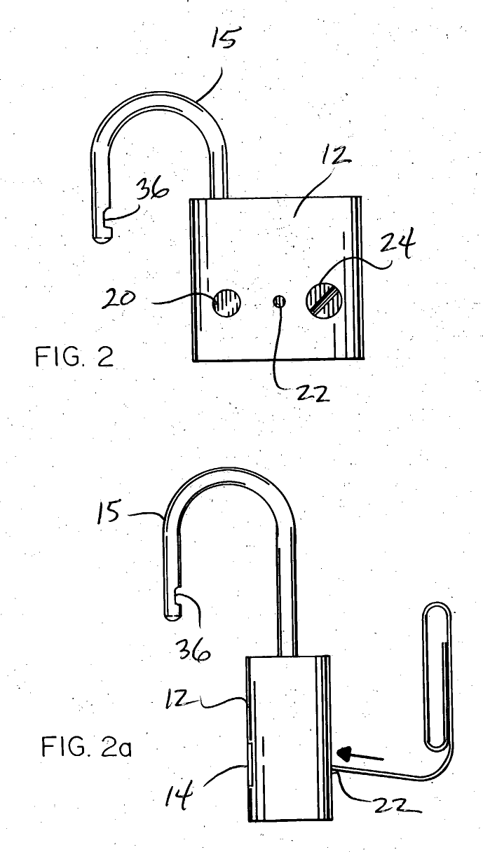

The body 12 is of conventional size and shape as compared to key lock or combination lock padlocks. Similarly, locking arm or shackle 15 is of a typical shape and size as compared to ordinary padlocks. However, unlike a conventional padlock, as shown in FIG. 1 and FIG. 1a padlock 10 comprises a biometric member having an unlock activation (“U”) button 18 and a fingerprint reader line sensor 16 on one side of the body 12 and as shown in FIG. 2 and FIG. 2a, a programming activation (“P”) button 20 and reset switch 22 on the opposite side of the body 12. Also included on that opposite side of body 12 is a battery access 24 which comprises a screwhead leading to an interior compartment (not shown) in which a small watch-type battery (not shown) is located.

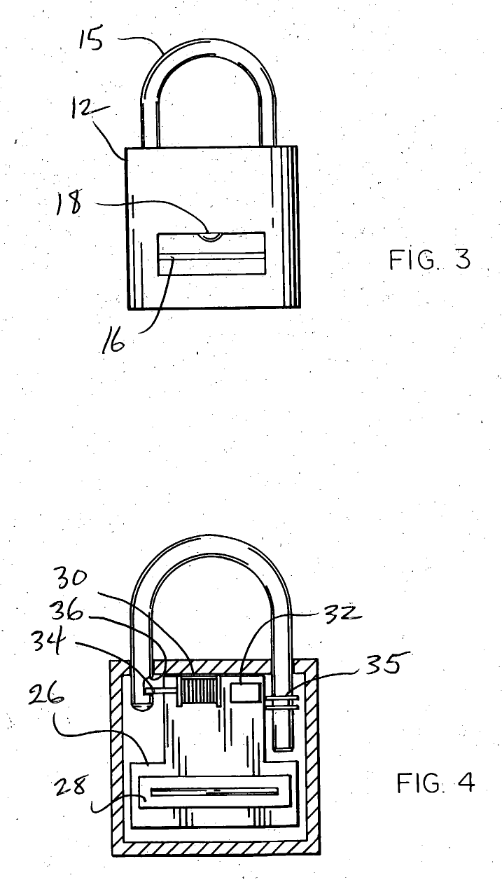

As seen best in FIG. 3 and FIG. 4, when the padlock 10 is locked, locking pin 34 sits in recess 36 of shackle 15. When properly activated by a recognized fingerprint scan, solenoid 30 is momentarily energized pulling the solenoid toward magnetic pole 32 and withdrawing pin 34 from recess 36. The shackle 15, which is preferably spring-loaded by spring 35, automatically springs open allowing the shackle to be rotated 180° out of the way to the open position shown in FIGS. 1, 1a and 2. When padlock 10 is to be locked into the position shown in FIG. 3, the shackle is rotated back and compressed until pin 34 enters recess 36. The now unenergized solenoid 30 is back in the configuration of FIG. 4.

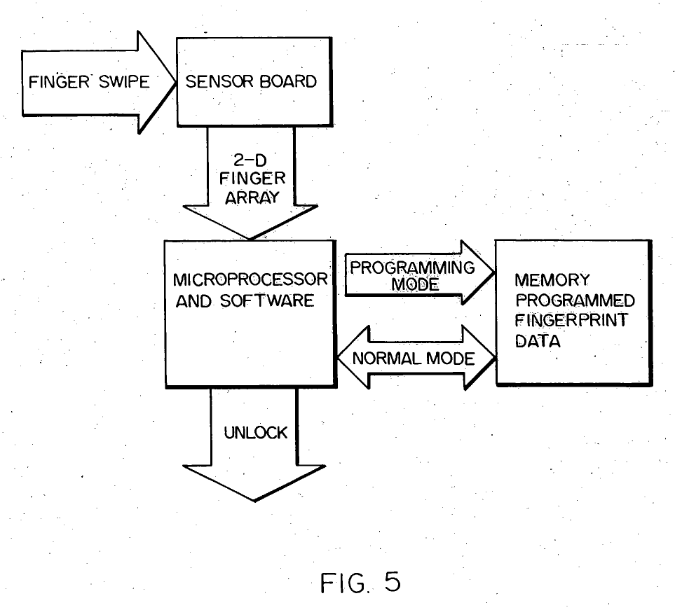

FIG. 5 illustrates in block diagram format, the principal flow and electronic hardware of the padlock 10. The latter comprises the sensor board 28, a microprocessor and associated software and related memory for storing programmed fingerprint data.

The lock has several modes of operation:

1. Unlock—to open the device one pushes the U Button momentarily which wakes up the lock (applies power) and activates the sensor and electronics. The U button is positioned near the sensor to be automatically depressed prior to passing the finger over the sensor. The finger is passed over the sensor and within 1-2 seconds a solenoid in the lock releases the spring-loaded shackle, which then pops up.

2. Program—The lock first needs to be programmed to be able to recognize the users' fingerprints. Up to 8 fingerprints may be stored. To program the lock one opens the shackle, rotates it 180°, and pushes the shackle down until it detents in place. One then pushes the P (program) button on the back and wipes a finger across the sensor. If the print is received, an LED will light up green. If the print is not recorded it will flash red. There may be a requirement to repeat the programming step twice. The lock is returned to this position only for programming additional prints. When the capacity for the number of prints is reached, the red light will go on and the green light will not flash.

3. Lock—Simply pull up on the shackle, rotate it 180° (from the programming mode) and push down on the shackle to Lock.

4. Remove programmed prints—To remove previously stored prints one is required to open the lock and depress the reset button (recessed below the casing using a paperclip.) The reset button will not work with the lock closed. There is no way to remove a subset of the fingerprints stored with the lock closed.

Battery—The lock is powered using a coin cell accessible via a screw cover on the back of the lock. This permits one to replace the battery if it expires while the lock is locked. However, even if the battery fails the lock will not open; its default position is in the closed locked condition.

Having thus disclosed an exemplary embodiment illustrating the inventive features of a best mode of the invention, it will now be apparent that various additions and modifications are contemplated. By way of example, the solenoid may be replaced by a small DC motor and wormscrew to facilitate grasping and releasing the shackle in response to a fingerprint match. Accordingly, the protection afforded hereby is not necessarily limited by the disclosed embodiment, but only by the scope of the claims appended hereto and their equivalents.

I claim:

1. A padlock having a body and a shackle having two ends, one end of the shackle being rotatably secured within the body, the other end of the shackle being releasable from the body when the padlock is unlocked; the padlock comprising:
a fingerprint scanning apparatus within said body and having a sensor accessible from the exterior of said body for scanning fingerprint indicia;
a memory device within said body for storing data corresponding to fingerprint indicia of at least one individual authorized to unlock said padlock;
means for comparing scanned fingerprint indicia with fingerprint indicia data stored in said memory device; and
means for releasing said other end of said shackle in response to said comparing means when said scanned fingerprint indicia matches said fingerprint data stored in said memory device.

2. The padlock recited in claim 1 wherein said releasing means comprises a solenoid.

3. The padlock recited in claim 2 wherein said solenoid is affixed to a locking pin and wherein said other end of said shackle comprises a recess for receiving said locking pin.

4. The padlock recited in claim 1 wherein said comparing means comprises a microprocessor.

5. The padlock recited in claim 1 further comprising an unlock activation button for activating said scanning apparatus for receiving fingerprint indicia to be compared with fingerprint indicia data stored in said memory device.

6. The padlock recited in claim 1 further comprising a programming activation button for activating said scanning apparatus for receiving fingerprint indicia to be stored in said memory device.

7. The padlock recited in claim 1 further comprising a reset switch for erasing said fingerprint indicia data stored in said memory device, when said padlock is unlocked.

8. The padlock recited in claim 1 wherein said shackle is spring loaded to unlock said padlock automatically when said other end is released.

9. A padlock comprising:
a body;
a shackle releasibly secured to said body;
an electrically-operated release mechanism contained in said body for selectively releasing said shackle;
a biometric sensor;
a biometric data storage device; and
a comparing device for comparing sensed biometric data with stored biometric data for activating said release mechanism when said sensed biometric data matches said stored biometric data.

10. The padlock recited in claim 9 wherein said biometric sensor comprises a fingerprint scanner.

11. The padlock recited in claim 9 wherein said release mechanism comprises a solenoid.

12. The padlock recited in claim 9 wherein said comparing device comprises a microprocessor.
